(19) United States
(12) Patent Application Publication
(10) Pub. No.: US 2022/0327213 A1
(43) Pub. Date: Oct. 13, 2022

(54) ZERO VULNERABILITY COMPUTING (ZVC) FOR THE NEXT GENERATION INTERNET DEVICES

(71) Applicant: Fazal RAHEMAN, Nagpur (IN)

(72) Inventor: Fazal RAHEMAN, Nagpur (IN)

(21) Appl. No.: 17/828,205

(22) Filed: May 31, 2022

Related U.S. Application Data
(60) Provisional application No. 63/202,188, filed on May 31, 2021.

(51) Int. Cl. G06F 21/57; H04L 9/00; G06F 21/62

(52) U.S. Cl. CPC G06F 21/57; H04L 9/008; G06F 21/6254; G06F 2221/034

(57) ABSTRACT

Building computer systems with zero attack surface to enable zero vulnerability computing (ZVC) is considered to be inconceivable in the prior art, because granting third-parties privileges to install & run diverse apps the very purpose of computer hardware and operating systems (OS). These permissions actually mandatory and make computers useable. It's the misuse of those privileges by bad actors that creates the attack surface and consequently the vulnerabilities. Prior art approaches include strategies & policies that reduce the attack surface, detect, monitor and patch vulnerabilities, install security firewalls and anti-malware. ZVC aims to reduce computer vulnerabilities to zero by completely obliterating the attack surface of a computing device, decentralizing user data away from centralized legacy servers, securing it with post-quantum and homomorphic cryptography, and further providing a universal human-computer interface that delivers all third-party content via network, without granting them any OS privileges.

### RELATED APPLICATION

This application claims the benefit of U.S. provisional patent application 63/202,188, “Zero Vulnerability Computing (ZVC) for the Next Generation Internet Devices”, filed by Fazal Raheman ON MAY 31, 2022. This provisional patent application is incorporated herein by reference.

### TECHNICAL FIELD

The present disclosure generally relates to cybersecurity systems. More particularly, the present disclosure relates to architecture that inherently provides a zero-vulnerability computing as a new computing paradigm by completely obliterating the computer's attack surface for securing the computer from all types of malware attacks.

### BACKGROUND

There are two Epochs in the evolution of current technological paradigms vis-à-vis Operating Systems (OS):

First Epoch: First computers do not come with OS. Modern OS was the beginning of the 1^{st} Epoch in computing, in terms of programmability, allowing the development and integration of application-layer on top of the OS stack that grants user privileges to install and run programs that make use of the underlying services via OS specific system calls. The OS API enables programmers to write and compile executable software, which cm be easily installed and executed by legitimate users to run programs of their choice. However, this computing model eventually became a source for massive software vulnerabilities; bad actors started exploiting to enter or extract data from the OS environment. These possible attack entry points on an OS are collectively termed as “attack surface.” It represents not only all the possible attack entry points on the OS but ail the apps that run on the OS, thereby increasing the entry points and the attack surface for injecting malicious code.

Second Epoch: Exploiting the attack surface became increasingly common after the birth of Internet in 1990 when more and more computers got connected. This was the beginning of the second epoch, which gave birth to an entirely new malware/cybercrime industry. Cybercrime is a world threat of tremendous impact and is exponentially evolving to one of mankind's biggest problems. Malware's global cost has been exponentially growing since 2015. The impact of cybercrime on society represents the greatest transfer of economic wealth in history. Evidence indicates that computer attack surface continues to rise, causing the vulnerabilities and their exploits to rise. A technology that kills the root cause will indeed be world changing.

Attack surfaces are a necessary evil that has existed since the evolution of operating systems in 1951. While OSs has made it possible for genuine programs to run on computers, they have also reluctantly kept the same door open for bad actors. Challenging that age-old convention would be as radical as radicality ever gets. Our approach will eventually close the door permanently to bad actors, while keeping the honest apps accessible, albeit in a different mode. If the attack surface is completely eliminated from the computers without compromising any of the existing functionalities, it will indeed be an epoch in the history of computers that will potentially kill the multi-trillion-cybercrime industry.

Through the history of computers we have come to live with the fact that if there is a computing device there has to be an “attack surface,” and there will be vulnerabilities. Beyond the OS attack surface (primary), apps also introduce their own attack surface (secondary). In simple terms, an OS provides the necessary substrate and privileges that allow any third party application to run on it. While genuine providers use it with owner permission to install apps, bad actors covertly use it to run malicious programs, turning it into an attack surface. While prior art teaches reduction of the attack surface, one cannot conceive to eliminating it entirely, because without a surface to allow apps to run on an OS, the computing device will be useless.

Most prior of strive to minimize the attack surface, but they fail to provide such a computing device or method that obliterates the attack surface completely to deliver zero vulnerability computing. Thus, there remains a significant need for improved systems and/or methods to provide a zero vulnerability computing device and method of implementation. A system which completely obliterates the attack surface of any computer to achieve zero vulnerability. Also, to deploy post-quantum cryptography (PQC) or homomorphic encryption (HE) to provide long-term communication security with remotely supported execution components, to provide intelligent human computer interface (HCI) for all 3rd party content delivered via network, and to disincentivize hackers with. AI-powered decentralization of user data away from centralized servers.

### SUMMARY

The summary of the invention does not necessarily disclose all the features essential for defining the invention: the invention may, reside in a sub-combination of the disclosed features.

It is an object of the present invention to provide an architecture that inherently provides a zero-vulnerability computing (ZVC) apparatus that completely obliterates the computer's attack surface at the OS level (primary attack surface) and at the application level (secondary attack surface) and to validate this architecture by designing a proof-of-concept ZVC enabled platform for securing data privacy and/or anonymity.

Another object of the present invention to provide a zero vulnerability computing device that will be free of any attack surface that hackers or cybercriminals exploit.

Another object of the present invention to provide a zero-vulnerability computing device, that's resistant to direct hack attacks originating from the user-space (application layer) in niche controlled environment.

Another object of the present invention is to deploy post-quantum cryptography (PQC) or homomorphic encryption (HE) to provide robust long-term communication security with remotely supported execution components.

Another object of the present invention is to provide intelligent human computer interface (HCI) for all 3rd party content delivered via network.

Another object of the present invention is to disincentivize hacker's with AI-powered decentralization of user data away from centralized servers.

Another object of the present invention is to prove the ZEROV concept in a typical end-node computing device arid an IoT device.

A Zero Vulnerability Computing device that deploys proprietary operating system software such as Supra Operating System (SOS) software layer to neutralize and deactivate all permissions and privileges that a computing device's host operating system (OS) conventionally grants to a third party application to install and run as an application layer. The SOS causing complete obliteration of the computing device's attack surface, thereby eliminating all computer's vulnerabilities that bad actors exploit to back computers via malware or intrusion techniques, while allowing all others genuine server-delivered third-party applications to run, thus securing the computer from any possible malware attack. The applications that load and execute on SOS are not limited to the Internet-delivered applications but include concurrently running pre-configured native applications.

The SOS provides a real time environment to run all variants of network delivered third party decentralized as well as centralized applications with all of their native features and functions retained. This eliminates the need for their direct installation on the host computing device or granting any host OS data privileges. Without direct installation, the host computing device remains secure all the time.

The SOS implements post-quantum homomorphic cryptography to secure personally identifiable information (PII) by preventing external OS-independent hacking attacks on authentication or access control that include but not limited to dictionary attacks, brute force attacks or man-in-the-middle (MITM) attacks.

A universal software infrastructure layer of supra operating system (SOS) piggybacking on top of either the kernel or shell of a host operating system comprising of a program execution prevention (PEP) engine that includes one or more ants executable modules that disable drivers, processes, executables for preventing direct installation and execution of all third-party end-user software applications, executable applets or scripts on the host OS, completely obliterating the potential attack surface of the host OS and, a human computer interface (HCI) engine that includes a universal user interface (UUI) and user experience (UX) module and a machine learning (ML) module that runs and analyses all the diverse third party end-user software applications delivered via network, including but not limited to productivity software applications, entertainment or gaming applications, social media applications, engineering, designing or modelling applications, communication applications and web browsing software, such a versatile user interlace allowing all third party applications to run online on the supra OS software program layer in online as well as offline mode with all of their native functions without direct installation on the host OS.

The universal user interface of the SOS is not only HTTP compliant, but also supports the delivers, retrieval or storage of remote resources using one or more of the known decentralized protocols that include but not limited, to blockchain, IPFS (inter-planetary file system), Data protocol, allowing the content creator to self-host web pages independent of paid hosting.

A method of rendering a computer system free from all potential malware attacks by installing on the computer's host operating system (OS) a software infrastructure layer of Supra OS that completely obliterates the attack surface of the host OS:

i) by disabling direct installation and execution of all third-party end-user software applications on the host OS by means of a program execution prevention (PEP) engine comprising of one or more drivers, processes or executables disabling programs, and, ii) by running all the diverse third-party end-user software applications delivered via network, including but not limited to productivity software applications, entertainment or gaming applications, social media applications, engineering, designing or modeling applications, communication applications and web browsing software.

A compact Zero Vulnerability Operating System (ZVOS) for computing device that completely obliterates any potential attack surface by rescinding all permissions and privileges to third party applications and providing its own user interface for running all third-party applications remotely as web applications.

The ZVOS runs as a thin SOS from either a NAND or NOR flash drive or any legacy data storage device ported to one or more legacy computing devices including but not limited to a desktop, a laptop, tablet PC, a handheld mobile device, a wearable device, an IoT device, or a remote server running one of the commercially available operating systems that include but not limited to Microsoft Windows®, Apple macOS®, iOS®, Linux®, Google Android®, Chromium®, or any of the variants thereof.

The SOS or ZVOS software integrates blockchain to securely share computing resources or bandwidth with peers for tokenized rewards, and to decentralize, anonymize and secure data storage of all personally identifiable information (PII) of the users that include but not limited to self-sovereign identity, personal biometric, financial and social data.

The SOS or ZVOS runs on a computing device as a web browser or a browser extension or a thin client.

The computing devices provide a switchable offline cold storage for long time secure PII data storage.

The above recited objects are achieved by providing a zero-vulnerability computing device having a supra OS (Operating System) software that completely obliterates the computing device's attack surface thereby preventing any malware to harm the computer.

### BRIEF DESCRIPTION OF THE DRAWINGS

The accompanying drawings are included to provide a further understanding of the present disclosure, and are incorporated in and constitute a part of this specification. The drawings illustrate exemplary embodiments of the present disclosure and, together with the description, serve to explain the principles of the present disclosure.

The diagrams are for illustration only, which thus is not a limitation of the present disclosure, and wherein:

FIGS. 1A-1B illustrates exemplary points of attacks in a computing device for example, OS directly or an authorized app installed on the OS.

FIGS. 1C-1D illustrates the positioning of ZEROV as a layer in a computing device to obliterate the primary attack surface of the underlying OS and to inherently remove the primary and the secondary (user-space software) attack surface, in accordance with an exemplary embodiment of the present disclosure.

FIGS. 2A-2D illustrates ZEROV Architecture and components thereof, in accordance with an exemplary embodiment of the present disclosure.

FIGS. 3A-3B and FIGS. 4A-4D illustrates a graphic explanation of the SOS concept, the attack surface of a computing system can be represented by a series of dents or serrations in each layer representing the privileges and permissions that OS directly grants to the application layer to install and run on it or allow the application to pass on the privileges to the next higher layer in computer ecosystem, in accordance with an exemplary embodiment of the present disclosure.

### DETAILED DESCRIPTION

The following is a detailed description of the embodiments of the disclosure illustrated in the accompanying drawings. The embodiments are in such detail as to clearly communicate the disclosure. However, the amount of detail offered is not intended to limit the anticipated variations of embodiments; on the contrary, the intention is to cover all modifications, equivalents, and alternatives falling within the spirit and scope of the present disclosure.

In the following description, numerous specific details are set forth in order to provide a thorough understanding of embodiments of the present invention. It will be apparent to one skilled in the art that embodiments of the present invention may be practiced without some of these specific details.

As used herein, the term engine refers to software, firmware, hardware, or other component that can be used to effectuate a purpose. The engine will typically include software instructions that are stored in non-volatile memory also referred to as secondary memory). When the software instructions are executed, at least a subset of the software instructions can be loaded into memory (also referred to as primary memory) by a processor. The processor then executes the software instructions in memory. The processor may be a shared processor, a dedicated processor, or a combination of shared or dedicated processors. A typical program will include calls to hardware components (such as I/O devices), which typically requires the execution of drivers. The drivers may or may not be considered part of the engine, but the distinction is not critical.

The computers are vulnerable to countless security breaches, the attack surface is “a necessary evil,” that people have come to live with. Based on our initial work on circumventing a computer's operating system, a computing device with zero user space attack surface is designed to eliminate all potential vulnerabilities. Such zero vulnerability computing (ZVC) is without much of compromise in running user layer apps that one needs to run, albeit in a different mode (remotely). Thus, under the assumption that the underlying kernel space software is properly secured (this by itself is a hard task but clearly easier than securing all the user space software not a priori known) the overall architecture will completely obliterate the attack surface enabling ZVC.

Securing the kernel-space software will be based on software security hardening techniques, as described below, which is feasible for targeted computing environments. To fully comprehend ZEROV breakthrough, first the current vulnerabilities trends and their exploitation by cybercriminals are reviewed.

In the current state-of the-art, the approach to improving security of a computer system is to measure the attack surface of a computer system, and minimize it with the following basic strategies: i) reducing the amount of code running, ii) reducing entry points available to untrusted users, and, iii) eliminating services requested by relatively few users. The Zero Trust architecture by NIST is also suggesting a similar strategy. Although the reduction of the attack surface helps to prevent many security failures, it does not mitigate the amount of damage an attacker could inflict once software vulnerability is found.

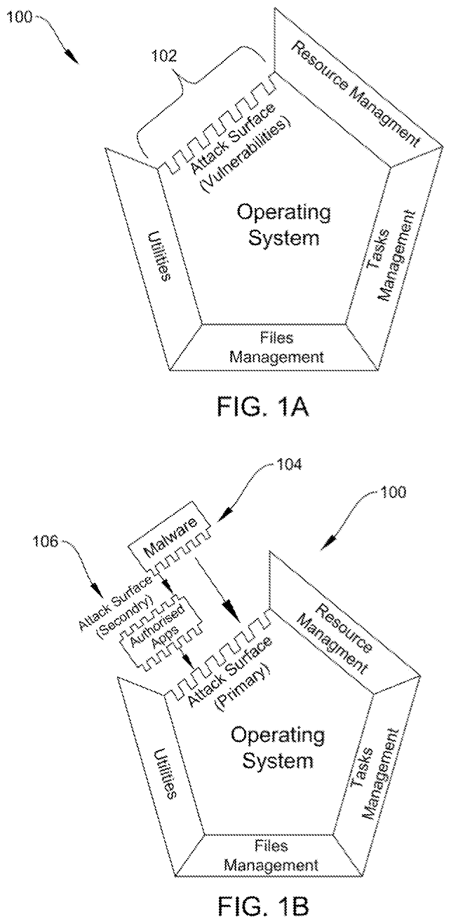

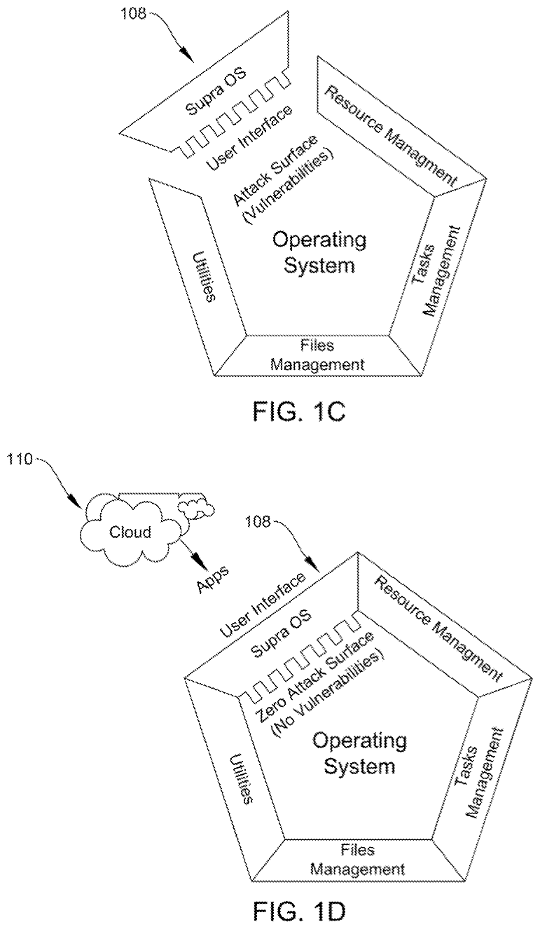

FIGS. 1A-1B illustrates exemplary points of attacks in a computing device 100 for example, OS directly or an authorized app installed on the OS.

It may be appreciated by the person skilled in the art that all computer vulnerabilities relate to the attack surface resulting from the permissions and privileges that the computer operating system (OS) grants 3^{rd} party application. It should be noted that without such OS permissions the computer will be unable to run applications and will be virtually useless. The attack surface is therefore considered “a necessary evil” in prior art. From the perspective of our ZEROV solution, as show in FIG. 1A the attack surface 102 may be primary 104 or secondary 106 depending on whether the point of attack is OS directly, or an authorized app installed on the OS.

As shown in FIG. 1B, the primary attack surface 102 is directly a target for creating OS vulnerabilities that are targeted by malware 104, which may also target the secondary attack surface 106 resulting from OS permissions to the application-layer software (including communication protocols) that run on top of the OS either directly or indirectly via a software or hardware bridge. The increasing amount of automation and the emergence of communication channels between previously independent objects increase the attack surface and expand the opportunities for adversaries to plan and execute their attacks.

FIGS. 1C-1D illustrates the positioning of ZEROV as an application layer Supra OS (SOS) 108 in a computing device 100 to completely obliterate the primary attack surface 102 of the underlying OS and to inherently remove the secondary (user-space software) attack surface 106, in accordance with an exemplary embodiment of the present disclosure. As a result, none of the 3^{rd} party applications can install or run on the OS. However, the SOS layer allows the cloud delivered apps 110 to run on the computing device 100 without any installation rights.

It may be appreciated by the person skilled in the art that attack surface/vulnerabilities keep growing. Since the advent of the Internet and birth of cybercrime industry, the attack surface is growing faster than ever before. The “attack surface” is simply the total digital resources that are exposed to threats across the enterprise. The severity of vulnerability or CVE (common vulnerabilities and exposure) is also growing. NVD (National Vulnerability Database) provides qualitative severity rankings of Low, Medium and High depending on CVSS (Common Vulnerabilities Scoring System) as defined in the CVSS v3.0 specification, which scores between 0-10 in increasing order of severity. Of the top 50 products reporting total number of distinct vulnerabilities in 2019, 100% of the vulnerabilities reported, OSs were directly or indirectly (via installed apps) were responsible.

It may be appreciated by the person skilled in the art that open source increases vulnerabilities and exploit speed. Code reusing is a common practice in software development due to its various benefits. Use of open source components in development increases vulnerabilities. Such a practice, however, causes large-scale security issues since one vulnerability may appear in many different software due to cloned code fragments. The rising trend has become a major reason for constantly expanding attack surface in the past decade. Findings from a DevSecOps community survey show that breaches related to open source components increased by 71% between 2014-2017. The trend is expected to grow in future as the open source components retain their popularity among the developers. This effect is particularly amplified in mobile app industry, where growth in new mobile apps is enormously higher compared to desktops.

On top of the software development trends that lead to increasing the attack surface, the DevSecOps are facing another challenge from hackers—The Exploit Speed. The speed of exploits has compressed by 93 percent. Now it is only 3 days before vulnerability is exploited as against 45 days in 2006. This means cybercriminals can exploit a new CVE as soon as it is released by just wing back to their catalog, and figuring out which systems are likely vulnerable to that particular CVE. This has given rise to increase in Zero-day vulnerability (a software security flaw known to the software vendor but may not have a patch in place to fix it).

It may be appreciated by the person Skilled in the art that Cybersecurity issues have worsened recently. Recent reports forecast a surge at 12.6% CAGR by 2027. Cyber Security Ventures predicts zero-day cyber-attacks are expected to rise from one per week to one per day by 2021.

Accordingly, an embodiment of the present invention provides Zero Vulnerability Computing (ZVC) to completely obliterate the attack surface of the underlying OS by means of a universal software infrastructure layer of Supra OS (SOS) that piggybacks on top of the device's host OS.

A ZVC device may be a desktop, a laptop, tablet PC, a handheld mobile device, a wearable device, an IoT device, and/or a remote server, running one of the commercially available operating systems that include but not limited to Microsoft Windows, Apple macOS, iOS, Linux, Google Android, Chromium, or any of their variants.

The SOS provides a real time environment to run all variants of network delivered third party decentralized as well as centralized applications with all of their native features and functions retained. This eliminating the need for their direct installation on the host computing device or granting any host OS data privileges. Without direct installation of any 3^{rd} party application, the host computing device remains secure all the time.

The SOS may also implement post-quantum cryptography or homomorphic cryptography to secure personally identifiable information (PII) to prevent external OS-independent hacking attacks on authentication or access control that include but not limited to dictionary attacks, brute force attacks or man-in-the-middle (MITM) attacks.

A universal software infrastructure layer of supra operating system (SOS) piggybacking on top of either the kernel or shell of a host OS comprising of a program execution prevention (PEP) engine that includes one or more anti-executable modules that disable drivers, processes, executables for preventing direct installation and execution of all third-party end-user software applications, executable applets or scripts on the host OS, completely obliterating the potential attack surface of the host OS. The SOS also comprises of a human computer interface (HCI) engine that includes a universal user interface (UUI), user experience (UX) module and a machine learning (ML) module that runs and analyses all the diverse third party end-user software applications delivered via network, including but not limited to productivity software applications, entertainment or gaming applications, social media applications, engineering, designing or modelling applications, communication applications and web browsing software. Such a versatile HCI allows all third party applications to run online on the SOS software program layer in online mode with all of their native functions without direct installation on the host OS. Such applications run as progressive web app (PWA). It may also allow select pre-configured applications to run in offline mode.

The universal user interface of the SOS is not only HTTP compliant, but also supports the delivery, retrieval or storage of remote resources using one or more of the known decentralized protocols that include but not limited to blockchain, IPFS (inter-planetary file system). Data protocol, allowing the content creator to self-host web pages independent of paid hosting.

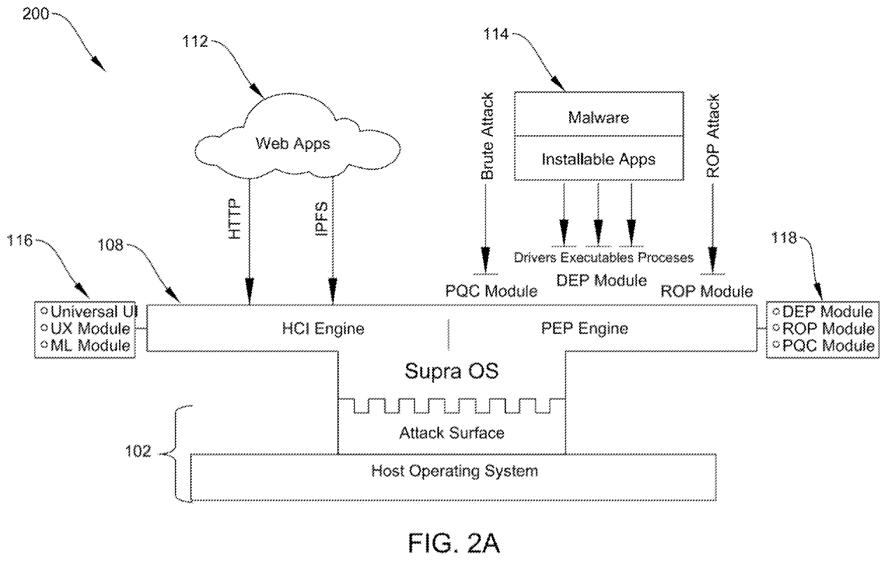

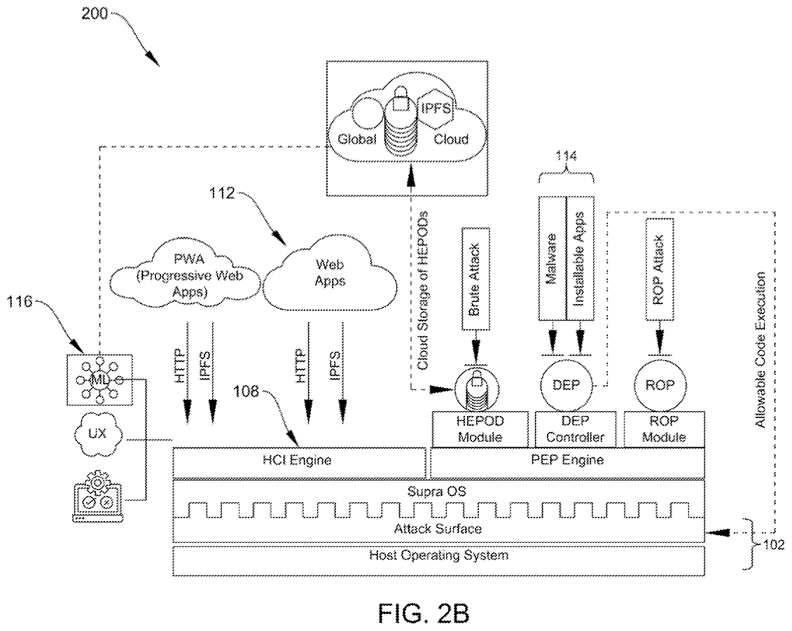

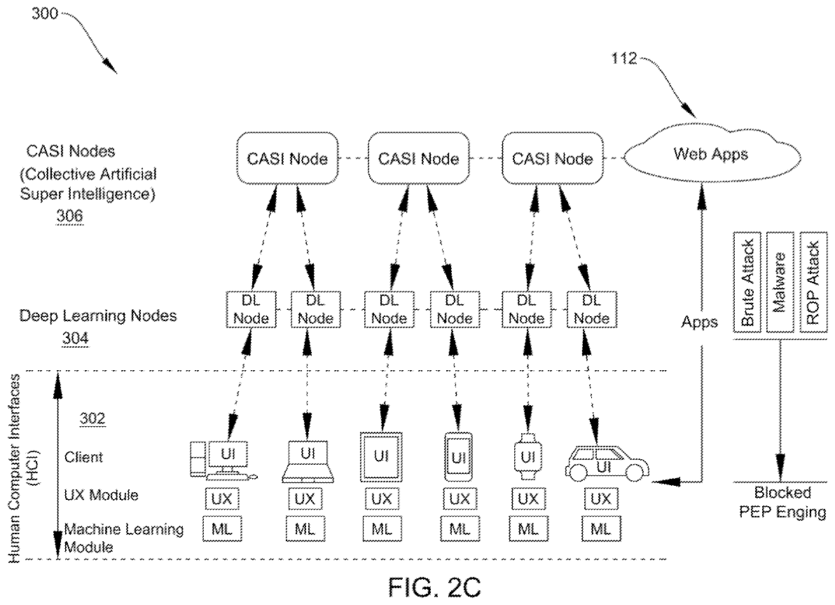

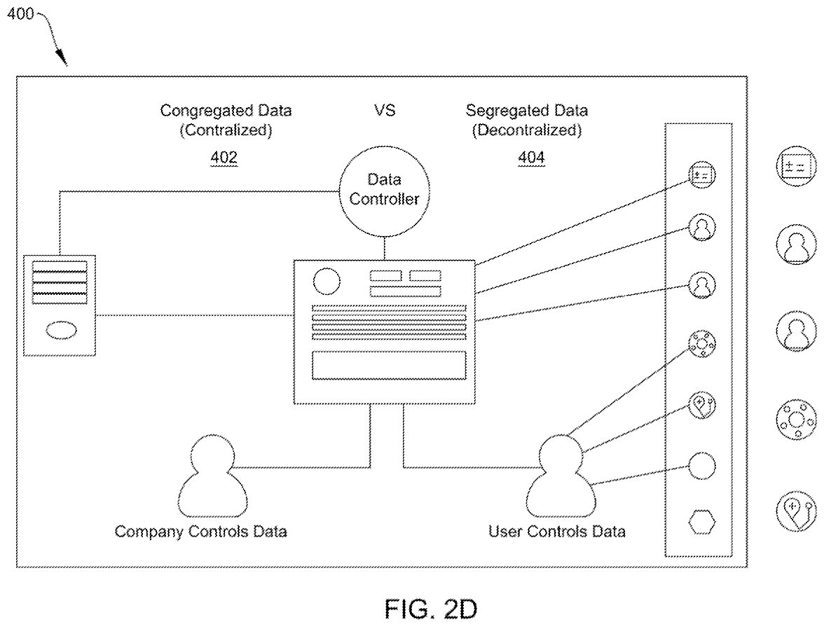

Further, FIGS. 2A-2D illustrates ZEROV Architecture and components 200 thereof in accordance with an exemplary embodiment of the present disclosure.

The practical implementation of ZVC device running Supra OS (SOS) 108 may follow the steps detailed herein:

A computer system may be rendered free from all potential malware attacks by installing on the computer's host OS a software infrastructure layer of SOS that completely obliterates the attack surface of the host OS by first disabling direct installation and execution of all third-party end-user software or installable applications 114 on the host OS by means of a program execution prevention (PEP) engine comprising of one or more drivers, processes or executables disabling programs, and second by running all the diverse third-party end-user software applications delivered via network, including but not limited to productivity software applications, entertainment or gaming applications, social media applications, engineering, designing or modelling applications, communication applications and web browsing software.

A Human Computer Interface (HCI) engine that includes a universal user interface (UUI), a user experience (UX) module and a machine Learning (ML) module 116 that runs and analyses all the diverse third party end-user software applications 112 delivered via network. The delivered applications may vary according to the scope of the computing device (e.g. productivity software, entertainment apps or web browsing software). Such a versatile user interface allowing all third party apps to run online on the zero attack surface SOS software program layer in online mode with all of their native functions (as progressive web apps) without direct installation on the host OS is not known to prior art. While depriving the 3^{rd} party applications all OS permissions, the SOS program can allow pre-configured 3^{rd} party applications to also run in offline mode. The PEP engine obliterates the attack surface of the host OS, preventing direct installation and execution of malicious software programs, securing the computer from malicious attacks. The network communication (remote application delivery) and the user authentication will he secured by applying PQC primitives or homomorphic encryption for long-term security guarantees.

The detailed architecture of Human Computer Interface (HCI) engine is shown in FIG. 2C, where in the HCI 302 of the Supra OS (SOS) 108 interacts with the deep learning nodes 304 and thereby with the CAST (collective Artificial Super Intelligence) nodes 306 to ensure that web-based apps 112 are efficiently accessed from the device 100.

The user data in the ZVC architecture is decentralized as against legacy systems wherein the user data is centralized in databases located on a remote server. FIG. 2D shows a comparison between traditional centralized databases 402 and decentralized data 404 implementation of the ZVC framework via the personal online data stores (PODs). The PODs enable privacy, security and interoperability by placing user data in direct control of the user segregated away from centralized legacy servers, rendering such PODs totally private, confidential and secure. Segregated or distributed user data is always more secure than congregated or centralized data.

The ZVC network architecture provides real time environment to run a desktop, laptop, tablet, handheld device, or an IoT device, all kinds of network-delivered third party decentralized as well as centralized applications with all of their native features and functions retained, eliminating the need for direct installation on the host OS thus rendering total freedom from app stores. The ZVC can be compatible with any commercially available Operating Systems, such as Microsoft Windows, Apple macOS, Linux, Google Android, iOS, Chromium, OxygenOS, by developing the relevant SOS module. The SOS can also support offline apps. AI will support user experience and interaction and therefore will enhance the security from the user awareness perspective.

The universal HCI of ZVC is not only HTTP compliant, but also supports delivery, retrieval or storage of remote resources using IPFS, consequently, granting the content creator complete freedom from paid hosting as IPFS protocol can host content for web delivery.

In an exemplary embodiment, ZVC can achieve systems interoperability and technical coherency. By creating, a supra OS layer that is application agnostic, ZVC can utilize its PEP engine to secure all network delivered applications and render all malicious executable codes and scripts futile. At the same time SOS keeps its own execution active to offer universal, user-friendly human-computer integration (HCI). It's ROP and PQC modules combat non-vulnerability attacks such as ROP (return oriented programming) or brute force, and makes trusted execution environment (TEE) redundant.

In another exemplary embodiment, ZVC deploys its application agnostic layer to battle cybersecurity attack vectors, while creating a universal interface that enhances the user experience by exploiting Web 3.0 technologies to enable the next generation Internet.

In an exemplary implementation, illustrated in FIG. 2B core components of ZVC, the PEP and HCI Engines and their 3 modules 118 (DEP, ROP and PQC), and (UI, UX and ML module) 116 respectively are defined. The backend of the ZVC ecosystem is decentralized to secure user data using open source SOLID (Social linked data) web technology. All the components are integrated in an installable SOS software.

In an exemplary implementation, the SOS software is forked from the chromium project to build a hack-proof device for corporates to implement their BYOD (bring your own device) policy for their employees. Further security of such devices can be boosted with PQC or homomorphic encryption techniques, and by implementing self-governing, legal, social and ethical rules that use ML/DL modules 116 to compile, collate and analyze users' collective wisdom to boost AI. ZVC, thus can prepare humanity for singularity in future, for warding off any potential AI threats.

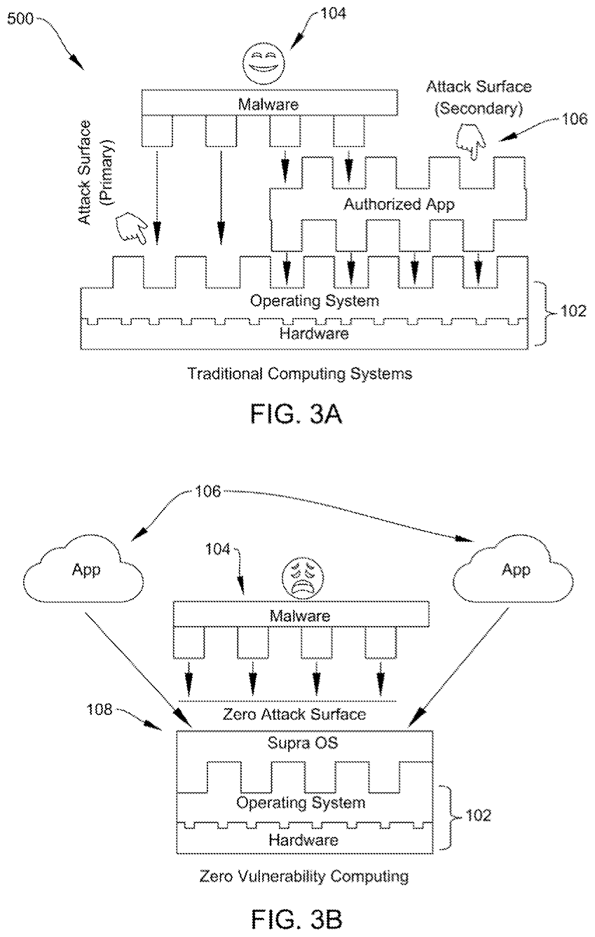

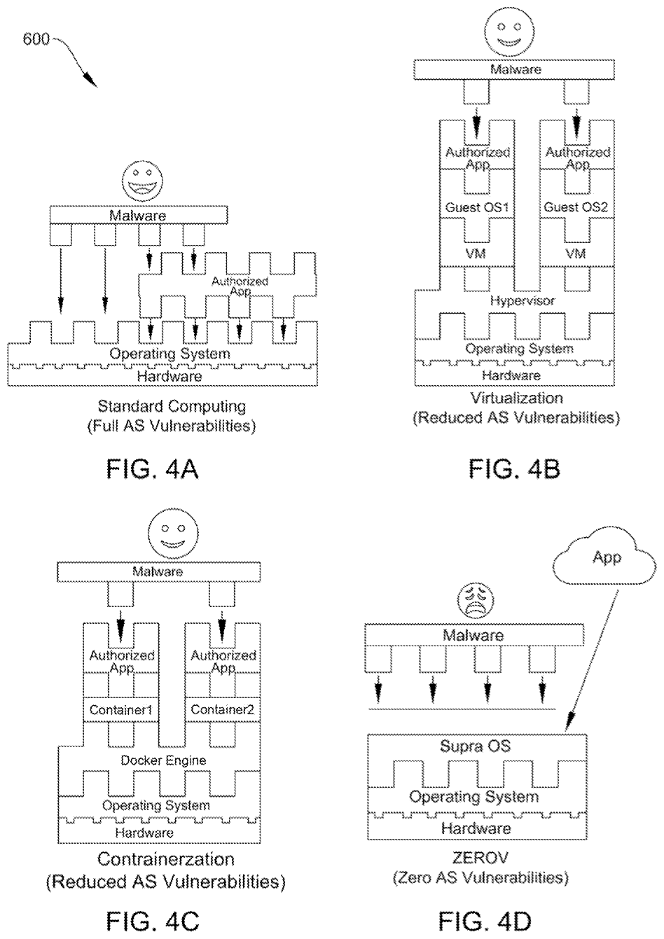

FIGS. 3A-3B 500 and FIG. 4A-4D 500 and 600 illustrates a graphic explanation of the SOS concept, the attack surface of a computing system can be represented by a series of dents or serrations in each layer representing the privileges and permissions that OS directly grants to the application layer to install and run on it or allow the application to pass on the privileges to the next higher layer in computer system, in accordance with an exemplary embodiment of the present disclosure. As graphically represented Supra. OS bears only one sided serrations, meaning SOS uses the permissions it install itself, but does not pass it on to the next layer. As a result nothing can be installed on the OS.

FIG. 3A illustrates the attack surface 102 may be primary 104 or secondary 106 depending on whether the point of attack is OS directly, or an authorized app installed on the OS. FIG. 3B illustrates the positioning of ZEROV as a layer 108 in a computing device 100 to circumvent the primary attack surface 104 of the underlying OS and to inherently remove the secondary (user-space software) attack surface 106, in accordance with an exemplary embodiment of the present disclosure. It may allow only the verified apps from the cloud to run on the ZVC device.

FIG. 4A-4D illustrate graphic representations of the various cybersecurity approaches available in prior art ranging from standard computing with fall attack surface vulnerabilities (4A), to reduced attack surface with virtualization (4B) and containerization (4C). FIG. 4D graphically illustrates the ZVC framework's complete obliteration of the attack surface.

In another exemplary implementation, ZVC is implemented as a compact Zero Vulnerability Operating System (ZVOS), particularly for IoT devices, that completely obliterates any potential attack surface by rescinding all permissions and privileges to third party applications and providing its own user interface for running all third-party applications remotely as web applications. ZVOS can enable IoT device development by adapting its PEP and HCI engines to a minimalistic requirement of the IoT devices limited by their processing power and limited range of third-party applications. Rest of the backend infrastructure of such a ZVC device may remain the same.

In yet another exemplary implementation, ZVOS runs as a thin SOS from either a NAND or NOR flash drive or any legacy data storage device ported to one or more legacy computing devices including but not limited to a desktop, a laptop, tablet PC, a handheld mobile device, a wearable device, an IoT device, or a remote server running one of the commercially available operating systems that include but not limited to Microsoft Windows, Apple macOS, iOS, Linux, Google Android, Chromium, or any of the variants thereof. In such ZVOS implementation of a thin ZVC device, the storage device is either permanently mounted on the USB port of the host computer or integrated within the motherboard of the host computer.

In still another exemplary implementation the SOS or ZVOS software integrates blockchain to securely share computing resources or bandwidth with peers for tokenized rewards, and to decentralize, anonymize and secure data storage of all personally identifiable information (PII) of the users that include but not limited to self-sovereign identity, personal biometric, financial and social data. Such SOS or ZVOS software may also be implemented on a computing, device as a web browser or a browser extension or a thin client.

Various modifications will be readily apparent to persons skilled in the art. The general principles defined herein may be applied to other embodiments and applications without departing from the spirit and scope of the invention. Moreover, all statements herein reciting embodiments of the invention, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure). Also, the terminology and phraseology used is for the purpose of describing exemplary embodiments and should not be considered limiting. Thus, the present invention is to be accorded the widest scope encompassing numerous alternatives, modifications and equivalents consistent with the principles and features disclosed. For purpose of clarity, details relating to technical material that is known in the technical fields related to the invention have not been described in detail so as not to unnecessarily obscure the present invention.

Terminology Used:

SOS: Supra OS or Supra Operating System;

PODs: Personal Online Data stores:

IPFS: Inter-planetary File System:

LIQUIDUS: Linkable Quarantined Internet Data of Unique Subjects;

API: Application Programming Interface;

PQC: Post Quantum Cryptography;

BYOD: Bring Your Own Device

1. A Zero Vulnerability Computing (ZVC) device to secure one or more computing environments by eliminating all the vulnerabilities exploited by one or more third party applications using malware or intrusion techniques, comprises:
a Supra Operating System (SOS) software layer to neutralize and deactivate all permissions and privileges that a computing device's host: operating system (OS) conventionally grants to one or more third party data to install and run as an application layer, thus such SOS causing complete obliteration of the computing device's attack surface:
a human computer interface (HCI) engine that includes an universal user interface (UUI) and an user experience (UX) module optimized and improved by, a machine learning (ML) module that runs and analyses all the diverse third party end-user software applications delivered via network, including but not limited to productivity software applications, entertainment or gaming applications, social media applications, engineering, designing or modelling applications, communication applications and web browsing software, such a versatile user interface allowing all third party applications to run online on the supra OS software program layer in online as well as offline mode with all of their native functions without direct installation on the host OS.

2. The computing device of claim 1, wherein the computing device is a desktop, a laptop, a tablet PC, a handheld mobile device, a wearable device, an IoT device, or a remote server, running one of the commercially available operating systems that include but not limited to Microsoft Windows®, Apple macOS®, iOS®, Linux®, Google Android®, Chromium®, or any of their variants.

3. The computing device of claim 1 wherein the SOS provides real time environment to run all variants of network delivered third party decentralized as well as centralized applications with all of their native features and functions retained, eliminating the need for their direct installation on the host computing device or granting any host OS data access privileges.

4. The computing device of claim 1 wherein the SOS implements post-quantum homomorphic cryptography to secure personally identifiable information (PII) by preventing external OS-independent hacking attacks on authentication or access control that include but not limited to dictionary attacks, brute force attacks or man-in-the-middle (MITM) attacks.

5. The universal software infrastructure layer of supra operating system (SOS) of claim 1, wherein the universal user interface of the SOS is not only HTTP compliant, but supports the delivery, retrieval or storage of remote resources using, one or more of the known decentralized protocols that include but not limited to blockchain, IPFS (inter-planetary file system), Data protocol, allowing, the content creator to self-host web pages independent of paid hosting.

6. The computing device of claim 1, wherein the computing device provides a switchable offline cold storage within the device itself for long time secure sensitive data storage.

7. A method of rendering a computer system free from all potential malware attacks by installing a software infrastructure layer of Supra OS that completely obliterates the attack surface of the host device hardware and OS:
disabling direct installation and execution of all third-party end-user software codes on the host by means of a program execution prevention (PEP) engine comprising of one or more drivers, processes or executables disabling programs; and
running all the diverse third-party end-user software applications delivered via network including but not limited to productivity software applications, entertainment or gaming applications, social media applications, engineering, designing or modelling applications, communication applications and web browsing software, on the decentralized or centralized network on the cloud to restrict any installation on the host operating system.

8. The method of claim 7 wherein the computing device is a desktop, a laptop, tablet PC, a handheld mobile device, a wearable device, an IoT device, or a remote server running one of the commercially available operating systems that include but not limited to Microsoft. Windows®, Apple macOS®, iOS®, Linux®, Google Android®, Chromium®, or any of their variants.

9. The method of claim 7 wherein the SOS provides real time environment to run all the variants of network delivered third party decentralized as well as centralized applications with all of their native features and functions retained, eliminating the need for direct installation on the host device or granting any OS data privileges.

10. The method of claim 7 wherein the SOS implements post-quantum homomorphic cryptography to secure PII for preventing external OS-independent hacking attacks on authentication or access control that include but not limited to dictionary attacks, brute force attacks or man-in-the-middle (MITM) attacks.

11. The method of claim 7 wherein the applications that load and execute on SOS are not limited to the Internet-delivered applications but include concurrently running pre-selected native applications.

12. The method of claim 7 wherein the universal user interface of the SOS is not only HTTP compliant, but supports the delivery, retrieval or storage of remote resources using one or more of the known decentralized protocols that include but not limited to blockchain, IPFS (inter-planetary file system), Data protocol, allowing the content creator to self-host web pages independent of paid hosting.

13. The method of claim 7, wherein the SOS software integrates blockchain to securely share computing resources or bandwidth with peers for tokenized rewards, and to decentralize, anonymize and secure data storage of all personally identifiable information (PII) of the users that include but not limited to self-sovereign identity, personal biometric, financial and social data.

14. A compact Zero Vulnerability Operating System (ZVOS) for computing device that completely obliterates any potential attack surface by rescinding all permissions and privileges to third party data and providing its own user interface for running all third-party applications remotely as web applications and securing the host computer from any remote hacking attack.

15. The computing device of claim 14 wherein the ZVOS runs as a thin SOS from either a NAND flash drive or any legacy data storage device ported to one or more legacy computing devices including but not limited to a desktop, a laptop, tablet PC, a handheld mobile device, a wearable device, an IoT device, or a remote server or any of the variants thereof.

16. The computing device of claim 14, wherein the SOS or ZVOS software integrates blockchain to securely share computing resources or bandwidth with peers for tokenized rewards, and to decentralize, anonymize and secure data storage of all personally identifiable information (PII) of the users that include but not limited to self-sovereign identity, personal biometric, financial and social data.

17. The computing device of claim 14 wherein the universal user interface of the ZVOS is not only HTTP compliant, but supports the delivery, retrieval or storage of remote resources using; one or more of the known decentralized protocols that include but not limited to blockchain, IPFS (inter-planetary file system), Data protocol, allowing the content creator to self-host web pages independent of paid hosting.

19. The computing device of claim 14, wherein the ZVOS provides real time environment to run all the variants of network delivered third party decentralized as well as centralized applications with all of their native features and functions retained, eliminating the need for direct installation on the host device or granting any data privileges.

20. The computing device of claim 14, wherein the SOS or ZVOS runs on a computing device a host OS-independent web browser or a thin client.
